(19) United States
(12) Patent Application Publication
(10) Pub. No.: US 2024/0132093 A1
(43) Pub. Date: Apr. 25, 2024

(54) DRIVING POLICY VISUALIZATION

(71) Applicant: AUTOBRAINS TECHNOLOGIES LTD, Tel Aviv-Yafo (IL)

(72) Inventors: Armin Biess, Tel-Aviv (IL); Isaac Misri, Tel-Aviv (IL); Joey Hendry, Bat-Yam (IL); Julius Engelsoy, Tel-Aviv (IL); Igal Raichelgauz, Tel Aviv (IL)

(73) Assignee: AUTOBRAINS TECHNOLOGIES LTD, Tel Aviv-Yafo (IL)

(21) Appl. No.: 18/400,823

(22) Filed: Dec. 29, 2023

Related U.S. Application Data
(63) Continuation-in-part of application No. 18/355,324, filed on Jul. 19, 2023.
Application No. 18/355,324 is a continuation-in-part of application No. 17/823,069, filed on Aug. 29, 2022.
Application No. 17/823,069 is a continuation-in-part of application No. 17/823,069, filed on Aug. 29, 2022.
(60) Provisional application No. 63/260,839, filed on Sep. 1, 2021.
(60) Provisional application No. 63/373,454, filed on Aug. 24, 2022.
(60) Provisional application No. 63/368,874, filed on Jul. 19, 2022.
(60) Provisional application No. 63/477,807, filed on Dec. 29, 2022.

(51) Int. Cl. B60W 50/14

(52) U.S. Cl. CPC B60W 50/14; B60W 2050/146

(57) ABSTRACT

A method for driving policy visualization, the method includes (i) receiving, by a processing circuit, perception information that comprises environmental information about an environment of a vehicle and kinematic information regarding a movement of the vehicle; (ii) receiving, by the processing circuit, a multidimensional virtual force field representation of a driving policy applicable to the vehicle; (iii) reducing a dimension of the multidimensional virtual force field representation, based on the received perception information, to produce a reduced dimensional virtual force field representation that conforms with a driving of the vehicle; and (iv) dynamically visualizing, by applying the reduced dimensional virtual force field representation, the driving policy in the driving of the vehicle.

### BACKGROUND

The development of autonomous vehicles that enable safe driving behavior and generate trust among drivers and passengers is still challenging due to the lack of explainability and transparency.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle and additional systems;

FIG. 2 illustrates an example of a method;

FIG. 3 illustrates examples of visualizations; and

FIG. 4 illustrates an example of a vehicle reaching a T-junction.

### DESCRIPTION OF EXAMPLE EMBODIMENT

Perception fields provide a promising computational framework to generate driving policies in autonomous vehicles by assigning force fields to each road object.

The one or more virtual forces represent one or more impacts of the one or more objects on a behavior of the vehicle. The impact may be a future impact or a current impact. The impact may cause the vehicle to change its progress.

The one or more virtual forces belong to a virtual physical model. The virtual physical model is a virtual model that may virtually apply rules of physics (for example mechanical rules, electromagnetic rules, optical rules) on the vehicle and/or the objects.

U.S. patent application Ser. No. 17/823,069 titled Perceptual Fields For Autonomous Driving, illustrates example of perception fields. In an example, impacts of objects on an ego vehicle are represented by virtual fields that apply virtual forces on the ego vehicle. A total virtual force applied on the ego vehicle is determined and used to determine a required virtual acceleration of the ego vehicle. The calculation of the required virtual acceleration of the vehicle at different points of time effectively determines a desired path of the ego vehicle.

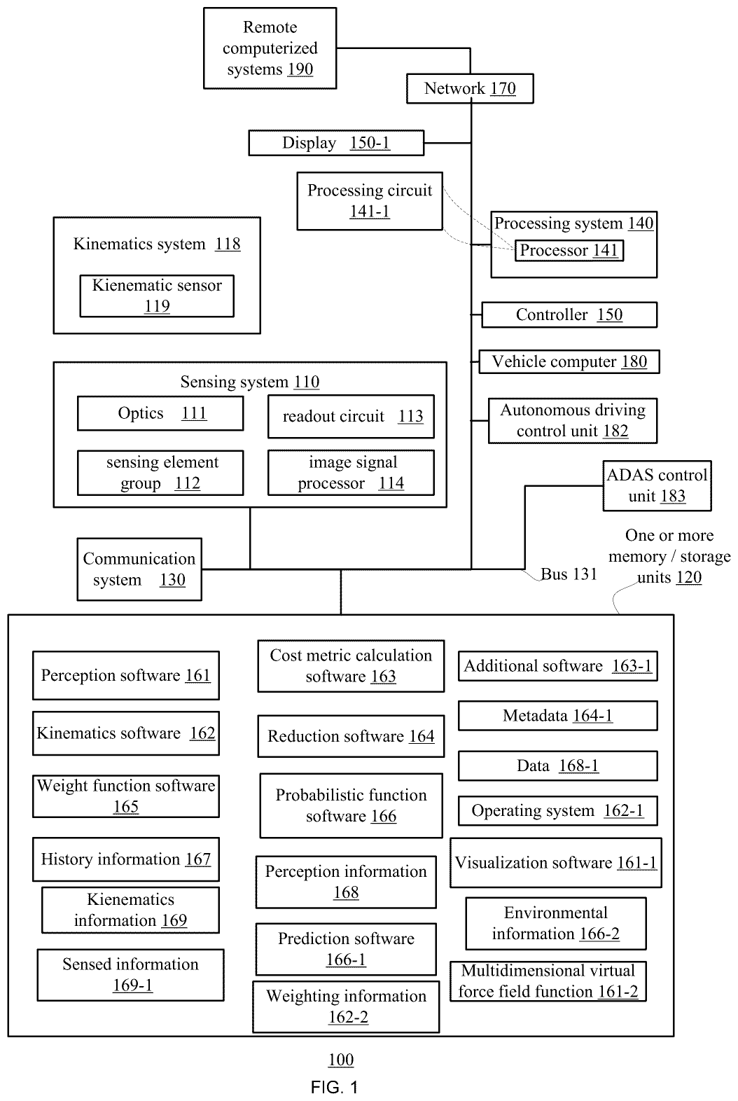

FIG. 1 illustrates an example of a vehicle 100 configured to provide policy visualization.

Vehicle 100 includes:
Kinematics system 118 configured to provide kinematics information 169, and includes one or more kinematics sensors such as a kinematics sensor 119 such as an accelerometer and/or a speed sensor, and the like. According to an embodiment, kinematics information includes at least one of speed, acceleration, or direction of propagation.
Sensing system 110 configured to sense the environment of the vehicle to provide sensed information) 69-1. The sensing system 110 and includes one or more sensors and related components—such as optics 111, sensing element group 112 (such as a line of sensing elements, a two-dimensional array of sensing elements, and the like), a readout circuit 113 and an image signal processor 114.
Communication system 130.
Bus 131.
One or more memory/storage units 120.
ADAS control unit 183.
Autonomous driving control unit 182.
Vehicle computer 180.
Controller 150.
Display 150-1. Other man machine interfaces may be provided.
Processing system 140 that includes one or more processors—such as processor 141 that includes one or more processing circuits—such as processing circuit 141-1. The processing system is configured to execute any method illustrated in the specification.

The communication system 130 is configured to enable communication between the one or more memory and/or storage units 120 and/or the sensing system 110 and/or any one of the additional units and/or the network 170 (that is in communication with remote computerized systems 190).

The controller 150 is configured to control the operation of the sensing system 110, and/or the one or more memory and/or storage units 120 and/or the one or more additional units (except the controller).

The ADAS control unit 183 is configured to control ADAS operations.

The autonomous driving control unit 182 is configured to control autonomous driving of the autonomous vehicle.

The vehicle computer 180 is configured to control the operation of the vehicle- especially control the engine, the transmission, and any other vehicle system or component.

The one or more memory and/or storage units 120 are configured to store firmware and/or software, one or more operating systems, data and metadata required to the execution of any of the methods mentioned in this application.

FIG. 1 illustrates the one or more memory and/or storage units 120 as storing: kinematics software 162 configured to generate kinematics information 169, perception software 161 configured to generate perception information 168, cost metric calculation software 163, reduction software 164, weight function software 165, probabilistic function software 166, history information 167, sensed information 169-1, prediction software 166-1, additional software 163-1, metadata 164-1, data 168-1, operating system 162-1, visualization software 161-1, weight information 162-2, multidimensional virtual force field function 161-2 that depends on multiple variables, environmental information 166-2.

The vehicle computer 180 may be in communication with an engine control module, a transmission control module, a powertrain control module, and the like

The memory and/or storage units 120 was shown as storing software. Any reference to software should be applied mutatis mutandis to code and/or firmware and/or instructions and/or commands, and the like.

According to an embodiment, the one or more memory and/or storage units 120 includes one or more memory unit, each memory unit may include one or more memory banks.

According to an embodiment, the one or more memory and/or storage units 120 includes a volatile memory and/or a non-volatile memory. The one or more memory and/or storage units 120 may be a random access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory unit.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols.

FIG. 1 illustrates communication system 130 as being in communication with various processors and/or units and network 17.

The communication system 130 is in communication with bus 131. This represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

FIG. 1 also illustrates network 170 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 130) which can be implemented in both wired and wireless environments. Such networking environments are conventional and commonplace in offices, enterprise-wide computer networks, intranets, and a network such as the internet.

According to an embodiment, processing system 140 is configured to receive perception information 168 that includes environmental information 166-2 about an environment of a vehicle, and kinematic information 169 regarding a movement of the vehicle.

According to an embodiment, processing system 140 is configured to receive multidimensional virtual force field function 161-2, that represents a driving policy applicable to the vehicle.

According to an embodiment, the driving policy is defined in any manner and/or by any entity—vehicle manufacturer, insurance company, driver, and the like.

According to an embodiment, the driving policy dictates allowable behaviors of a vehicle when facing different situations.

According to an embodiment, the driving policy is operative to determine one or more operational commands to affect driving related function of the vehicle. For example—when facing a certain situation the driving policy may is operative to determine one or more operational commands such slowing the vehicle, stopping the vehicle, accelerating the vehicle, changing a direction of progress, maintaining a direction of progress, and the like.

The multidimensional virtual force field function is dependent on non-marginal variables and of one or more marginal variables.

According to an embodiment, the multidimensional virtual force field function is generalized by introducing a weight information 162-2 and/or a weighting function. Any reference to weight information should be applied, mutatis mutandis to the weighting function.

According to an embodiment, the weighting function represents a probabilistic distribution of heading directions of the vehicle.

According to an embodiment, the weight information 162-2 is generated and/or applied by executing weight function software 165.

According to an embodiment, the probabilistic distribution is determined by applying probabilistic function software 166, based on any kind of predictive information that can be used for predicting the future heading direction of the vehicle.

According to an embodiment, the prediction of the future heading direction of the vehicle is generated by executing prediction software 166-1.

According to an embodiment, the probabilistic distribution is determined based on a location of the vehicle and of known information regarding the possible heading direction of a vehicle at that location.

According to an embodiment, the probabilistic distribution is determined based on information sensed by one or more sensors associated with the vehicle. The sensed information is a part of the perception information. A sensor associated with the vehicle may belong to the vehicle, may be located within the vehicle, or may be a sensor located outside the vehicle but having its sensed information accessible to the vehicle.

According to an embodiment, the probabilistic distribution is determined based on location and/or behavior of one or more road users located within the environment of the vehicle. For example—if a lane is blocked by a vehicle—the chances of proceeding to this probabilistic function software are lower than proceeding to a nearby lane associated with the same driving direction.

According to an embodiment, the probabilistic distribution is determined based on the road or roads that are downstream to the vehicle.

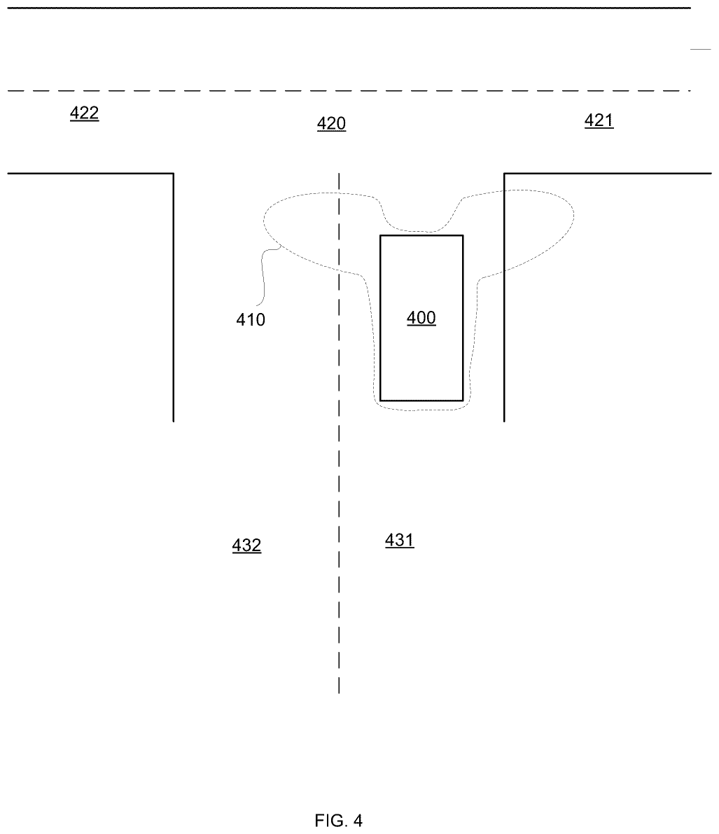

For example—when the vehicle is headed towards a T-junction—more weight is assigned to turning left or right. See, for example FIG. 4 that illustrates vehicle 400 that approaches (from a dual-lane dual direction road having a right lane 431 and 432) T-junction 420. The T-junction 420 having a left branch 422 and a right branch 421. More weight is assigned to turning left and turning right—as illustrated by probabilistic distribution 410—having a front-right lobe and a front-left lobe that are more distance from the vehicle—in relation to the rest of the probabilistic distribution 410.

According to an embodiment, the probabilistic distribution is determined based on an indication of the driver—such as signaling that the vehicle is about to turn left or right, and the like.

According to an embodiment, the probabilistic distribution is determined based on driving history of the vehicle when located at the location of the vehicle, and/or when facing the situation faced by the vehicle, and/or based on paths to popular destinations of the driver and/or of a larger group of people. The history of the driver or any other related history is represented by history information 167.

According to an embodiment, the probabilistic distribution is determined based on current heading of the vehicle.

According to an embodiment, reduction software 164 is executed for reducing a dimension of the multidimensional virtual force field function, based on the received perception information, to produce a reduced dimensional virtual force field function that conforms with a driving of the vehicle.

Visualization software 163-1 is executed for dynamically visualizing, by applying the reduced dimensional virtual force field function, the driving policy in the driving of the vehicle.

According to an embodiment, the dynamically visualizing includes generating visualization information and/or visualization instructions that once executed result in displaying the outcome of applying the reduced dimensional virtual force field function.

The dynamically visualizing may include displaying the visualization information and/or visualization instructions on a display 150-1 of a vehicle, on a display of a user device (for example on a mobile phone), and the like.

According to an embodiment, weight function software 165 is executed for determining weight information based on the perception information.

According to an embodiment, the reduction is responsive to the weight information.

According to an embodiment, the weight information is based on estimated future directions of progress of the vehicle.

According to an embodiment, the reduction involves integrating the multidimensional virtual force field function with respect to a marginal variable.

According to an embodiment, the reduction is responsive to the weight information.

According to an embodiment, the processing system is configured to select which variable (or variables) of the multidimensional virtual force field function is (are) the marginal variable.

According to an embodiment, the section is based on the perception information.

According to an embodiment, the reducing the includes applying a summing operation on a marginal variable of the multidimensional virtual force field function. The summing may be applicable in discrete multidimensional virtual force field function. Any reference to integrating should be applied mutatis mutandis to summing. The summing may be a weighted sum that represents the weight information.

According to an embodiment, there are provided multiple manners to execute the reducing—and the processing system 140 is configured to determine a manner of reducing based on a cost metric (calculated by executing cost metric calculation software 163). The manner of reducing may include determining one or more marginal variable, determining which weighting function to apply, determining a resolution of calculation, how to integrate or sum variables, ranges of values of variable being integrated, and the like. The cost metric may represent the resources required for reducing—memory and/or processing resources.

According to an embodiment, the reduction—especially a type of marginalization depends on the specific form of the multidimensional virtual force function. For example, in a lane centering task, the multidimensional virtual force function F=(Fₓ,F_{y})^{T} depends on the absolute speed v and implicitly on the vehicle position x and the ego heading θ, i.e,

F(v,x,θ)=π(v,a^{l}(x,θ),a^{r}(x,θ)) (1)

Where a^{l}(x,θ) and a^{r}(x,θ) are coefficients of estimated second order polynomials fitted to the left and right lane, respectively. We can now marginalize over all directions, giving:

$$F ( v , x ) = \frac{1}{π} {\int }_{0}^{2 π} F ( v , x , θ ) d θ \qquad ( 2 )$$

This expression can be further generalized by introducing a weighting function w(θ), which, for example, gives larger weights to angles around the actual heading direction, i.e.,

$$F ( v , x ) = \frac{1}{π} {\int }_{0}^{2 π} w ( θ ) F ( v , x , θ ) d θ , with {\int }_{0}^{2 π} w ( θ ) d θ = 1 \qquad ( 3 )$$

In addition, we can compute the magnitude of the expression as

F(v,x)=∥F(x,v)∥ (4)

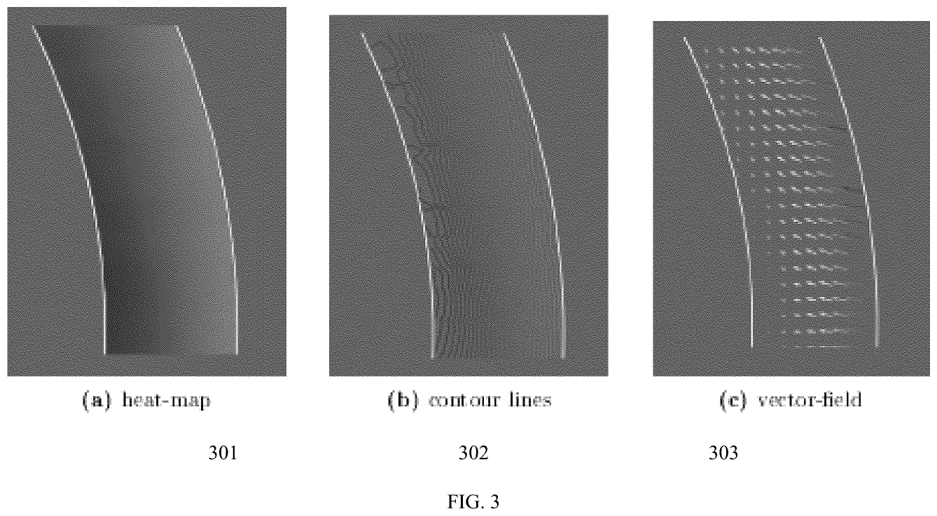

According to an embodiment, expressions (2), (3) and (4) are used for vector and contour/heat map visualizations—see for example, FIG. 3.

It should be noted that a specific marginalization induces a certain interpretation of the perception field. For example, for the lane centering task, the field strength of the perception field encodes the average force over all potential heading directions at each location.

In general, the multidimensional virtual force function has the form: F(x₁, x₂, . . . xᵢ, . . . xₙ), where x_{1 . . .} xₙ are a set of state variables (kinematic and/or contextual variables). A contextual variable may be an environmental variable or any other perception variable.

Marginalization of the virtual force may lead to the following reduced virtual force:

f(x₁,x₂, . . . , xᵢ)=∫w(xᵢ₊₁, . . . xₙ)F(x₁,x₂, . . . xᵢ,xᵢ₊₁ . . . xₙ)dxᵢ₊₁ . . . dxₙ

And the magnitude of the expression may be: f(x₁, x₂, . . . , xᵢ)=∥f(x₁, x₂, . . . , xᵢ)∥

Whereas ∫w(xᵢ₊₁, . . . xₙ)dxᵢ₊₁ . . . dxₙ=1.

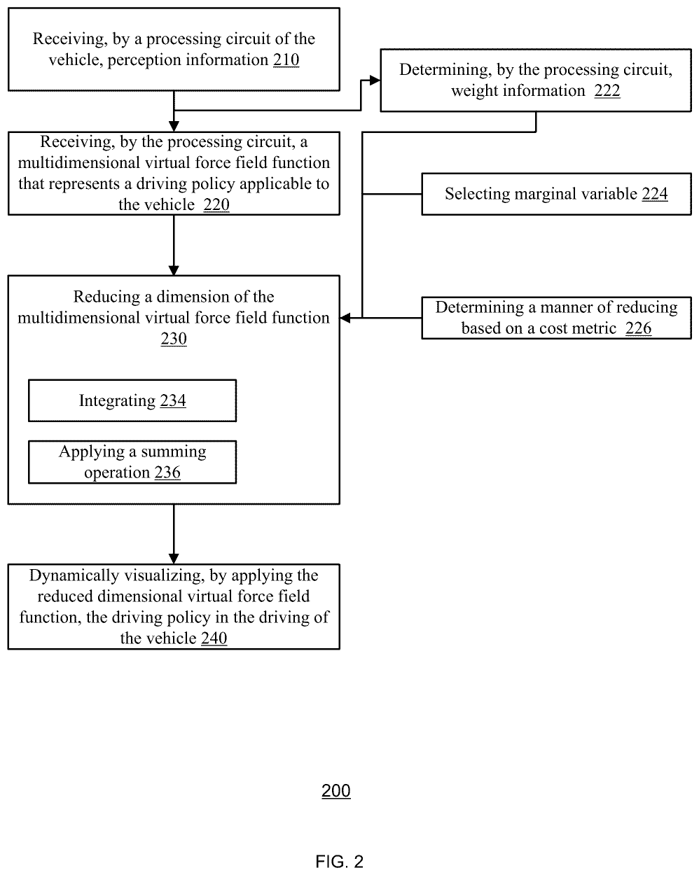

FIG. 2 illustrates an example of method 200 for driving policy visualization.

According to an embodiment, method 200 starts by step 210 of receiving, by a processing circuit of the vehicle, perception information that includes environmental information about an environment of a vehicle and kinematic information regarding a movement of the vehicle.

According to an embodiment, method 200 also includes step 220 of receiving, by the processing circuit, a multidimensional virtual force field function that represents a driving policy applicable to the vehicle.

The multidimensional virtual force field function is dependent on non-marginal variables and of one or more marginal variables.

According to an embodiment, the multidimensional virtual force field function is generalized by introducing a weight information and/or a weighting function. Any reference to weight information should be applied, mutatis mutandis to the weighting function.

According to an embodiment, the weighting function represents a probabilistic distribution of heading directions of the vehicle.

According to an embodiment, the probabilistic distribution is determined based on any kind of predictive information that can be used for predicting the future heading direction of the vehicle.

According to an embodiment, the probabilistic distribution is determined based on a location of the vehicle and of known information regarding the possible heading direction of a vehicle at that location.

According to an embodiment, the probabilistic distribution is determined based on information sensed by one or more sensors associated with the vehicle. The sensed information is a part of the perception information. A sensor associated with the vehicle may belong to the vehicle, may be located within the vehicle, or may be a sensor located outside the vehicle but having its sensed information accessible to the vehicle.

According to an embodiment, the probabilistic distribution is determined based on location and/or behavior of one or more road users located within the environment of the vehicle. For example—if a lane is blocked by a vehicle—the chances of proceeding to this lane are lower than proceeding to a nearby lane associated with the same driving direction.

According to an embodiment, the probabilistic distribution is determined based on the road or roads that are downstream to the vehicle.

For example—when the vehicle is headed towards a T-junction—more weight is assigned to turning left or right.

According to an embodiment, the probabilistic distribution is determined based on an indication of the driver—such as signaling that the vehicle is about to turn left or right, and the like.

According to an embodiment, the probabilistic distribution is determined based on driving history of the vehicle when located at the location of the vehicle, and/or when facing the situation faced by the vehicle, and/or based on paths to popular destinations of the driver and/or of a larger group of people.

According to an embodiment, the probabilistic distribution is determined based on current heading of the vehicle.

According to an embodiment, steps 210 and 220 are followed by step 230 of reducing a dimension of the multidimensional virtual force field function, based on the received perception information, to produce a reduced dimensional virtual force field function that conforms with a driving of the vehicle.

According to an embodiment, step 230 is followed by step 240 of dynamically visualizing, by applying the reduced dimensional virtual force field function, the driving policy in the driving of the vehicle.

The dynamically visualizing may be performed in real-time during the driving of the vehicle.

The dynamically visualizing includes generating visualization information and/or visualization instructions that once executed result in displaying the outcome of applying the reduced dimensional virtual force field function.

The dynamically visualizing may include displaying the visualization information and/or visualization instructions on a display of a vehicle, on a display of a user device (for example on a mobile phone), and the like.

According to an embodiment, step 210 is also followed by step 222 of determining, by the processing circuit, weight information based on the perception information.

According to an embodiment, step 230 is responsive to the weight information.

According to an embodiment, step 222 is based on estimated future directions of progress of the vehicle.

According to an embodiment, step 230 includes step 234 of integrating the multidimensional virtual force field function with respect to a marginal variable.

According to an embodiment, step 234 is responsive to the weight information.

According to an embodiment, method 200 includes step 224 of selecting which variable (or variables) of the multidimensional virtual force field function is (are) the marginal variable.

According to an embodiment, step 224 is based on the perception information.

According to an embodiment, step 230 includes step 236 of reducing the dimension by applying a summing operation on a marginal variable of the multidimensional virtual force field function. The summing may be applicable in discrete multidimensional virtual force field function. Any reference to integrating should be applied mutatis mutandis to summing The summing may be a weighted sum that represents the weight information.

According to an embodiment, there are provided multiple manners to execute the reducing—and method 200 includes step 226 of determining a manner of reducing based on a cost metric. The manner of reducing may include determining one or more marginal variable, determining which weighting function to apply, determining a resolution of calculation, how to integrate or sum variables, ranges of values of variable being integrated, and the like. The cost metric may represent the resources required for reducing—memory and/or processing resources.

FIG. 3 illustrates examples of visualizations in a lane centering task.

Image 301 is a heat map.

Image 302 is a contour plot.

Image 303 is a vector-field.

The images are acquired at a vehicle speed of 36 km/h.

The intensity of the force in image 301 and in image 302 is encoded in the color code—weak force at the left part of the lane and strong force at the right part of the lane. The intensity of the force in image 303 is the length of the vector.

A function is an example of a representation. For example—a multidimensional virtual force field function is an example of a representation of the multidimensional virtual force field, a reduced dimensional virtual force field function is an example of a reduced dimensional virtual force field. The representation may differ from a function.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like.

The vehicle may be any type of vehicle—including, for example, a ground transportation vehicle, an airborne vehicle, and a water vessel.

Object information may include any type of information related to an object such as but not limited to a location of the object, a behavior of the object, a velocity of the object, an acceleration of the object, a direction of a propagation of the object, a type of the object, one or more dimensions of the object, and the like. The object information may be a raw SIU, a processed SIU, text information, information derived from the SIU, and the like.

An obtaining of object information may include receiving the object information, generating the object information, participating in a processing of the object information, processing only a part of the object information and/or receiving only another part of the object information.

The obtaining of the object information may include object detection or may be executed without performing object detection.

A processing of the object information may include at least one out of object detection, noise reduction, improvement of signal to noise ratio, defining bounding boxes, and the like.

The object information may be received from one or more sources such as one or more sensors, one or more communication units, one or more memory units, one or more image processors, and the like.

The object information may be provided in one or more manners—for example in an absolute manner (for example—providing the coordinates of a location of an object), or in a relative manner—for example in relation to a vehicle (for example the object is located at a certain distance and at a certain angle in relation to the vehicle.

The vehicle is also referred to as an ego-vehicle.

The specification and/or drawings may refer to a processor or to a processing circuitry. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

In the foregoing specification, the invention has been described with reference to specific examples of embodiments of the invention. It will, however, be evident that various modifications and changes may be made therein without departing from the broader spirit and scope of the invention as set forth in the appended claims. Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality. Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for driving policy visualization, the method comprises:
receiving, by a processing circuit, perception information that comprises environmental information about an environment of a vehicle and kinematic information regarding a movement of the vehicle;
receiving, by the processing circuit, a multidimensional virtual force field representation of a driving policy applicable to the vehicle;
reducing a dimension of the multidimensional virtual force field representation, based on the received perception information, to produce a reduced dimensional virtual force field representation that conforms with a driving of the vehicle; and
dynamically visualizing, by applying the reduced dimensional virtual force field representation, the driving policy in the driving of the vehicle.

2. The method according to claim 1, further comprising determining, by the processing circuit, weight information based on the perception information.

3. The method according to claim 2, wherein the reducing of the dimension is based on the weight information.

4. The method according to claim 2, comprising determining the weight information is based on estimated future directions of progress of the vehicle.

5. The method according to claim 1, comprising reducing the dimension by integrating the multidimensional virtual force field representation with respect to a marginal variable.

6. The method according to claim 5, wherein the integrating is further responsive to weight information.

7. The method according to claim 5, further comprising selecting the marginal variable based on the perception information.

8. The method according to claim 1, comprising reducing the dimension by applying a summing operation on a marginal variable of the multidimensional virtual force field representation.

9. The method according to claim 1, wherein the reduced dimensional virtual force field representation is indicative of an impact of the driving policy on the vehicle.

10. The method according to claim 1, wherein the reducing is determined based on a cost metric.

11. The method according to claim 1, wherein the driving policy is operative to determine one or more operational commands to affect driving related function of the vehicle.

12. A non-transitory computer readable medium for driving policy visualization, the non-transitory computer readable medium storing instructions that, when executed by at least one processor, cause the at least one processor to perform operations for field related driving, comprising:
receiving content from an information source located outside of a vehicle;
obtaining object information regarding one or more objects located within an environment of the vehicle;
estimating, by using a neural network (NN), and based on the object information, one or more virtual fields of the one or more objects; and
determining, based on the one or more virtual fields, a virtual force for use in applying a driving related operation of the vehicle, wherein the virtual force is associated with a physical model and representing an impact of the one or more objects on a behavior of the vehicle; and
wherein at least one step of the obtaining, the estimating and the determining is impacted by the content.
receiving, by a processing circuit, perception information that comprises environmental information about an environment of a vehicle and kinematic information regarding a movement of the vehicle;
receiving, by the processing circuit, a multidimensional virtual force field representation of a driving policy applicable to the vehicle;
reducing a dimension of the multidimensional virtual force field representation, based on the received perception information, to produce a reduced dimensional virtual force field representation that conforms with a driving of the vehicle; and
dynamically visualizing, by applying the reduced dimensional virtual force field representation, the driving policy in the driving of the vehicle.

13. The non-transitory computer readable medium according to claim 12, further storing instructions for determining, by the processing circuit, weight information based on the perception information.

14. The non-transitory computer readable medium according to claim 13, wherein the reducing of the dimension is based on the weight information.

15. The non-transitory computer readable medium according to claim 13, storing instructions for determining the weight information is based on estimated future directions of progress of the vehicle.

16. The non-transitory computer readable medium according to claim 12, storing instructions for reducing the dimension by integrating the multidimensional virtual force field representation with respect to a marginal variable.

17. The non-transitory computer readable medium according to claim 16, wherein the integrating is further responsive to weight information.

18. The non-transitory computer readable medium according to claim 16, further storing instructions for selecting the marginal variable based on the perception information.

19. The non-transitory computer readable medium according to claim 12, storing instructions for reducing the dimension by applying a summing operation on a marginal variable of the multidimensional virtual force field representation.

20. The non-transitory computer readable medium according to claim 12, wherein the reduced dimensional virtual force field representation is indicative of an impact of the driving policy on the vehicle.
